(19) United States
(12) Patent Application Publication
(10) Pub. No.: US 2026/0134652 A1
(43) Pub. Date: May 14, 2026

(54) FEW-SHOT OBJECT DETECTION WITH VISION-LANGUAGE MODELS

(71) Applicants: Robert Bosch GmbH, Stuttgart (DE); Carnegie Mellon University, Pittsburgh, PA (US)

(72) Inventors: Anish Madan, Pittsburgh, PA (US); Neehar Peri, Monmouth Junction, NJ (US); Shu Kong, Taipa (MO); Deva Ramanan, Pittsburgh, PA (US); Chaithanya Kumar Mummadi, Coraopolis, PA (US); Filipe Condessa, Pittsburgh, PA (US)

(21) Appl. No.: 18/945,098

(22) Filed: Nov. 12, 2024

(51) Int. Cl. G06V 10/25; B25J 9/16; G06V 10/764; G06V 20/70

(52) U.S. Cl. CPC G06V 10/25; B25J 9/1697; G06V 10/764; G06V 20/70; G06V 2201/07

(57) ABSTRACT

A fine-tuned model for few-shot object detection is output. A dataset of K-shot classes is created for fine-tuning a pretrained vision language model (VLM). Concept alignment is performed between the dataset of K-shot classes and the VLM. Fine-tuning is performed on the VLM using the dataset of K-shot classes with pseudo-negative federated loss to generate a few-shot object detection (FSOD) model. The FSOD model is output for use in object detection of the K-shot classes in image data received from one or more sensors.

### TECHNICAL FIELD

Aspects of the disclosure relate to revisiting few-shot object detection with vision-language models.

### BACKGROUND

Few-shot object detection (FSOD) is a technique for detecting new categories with limited training data. Recent work explores two primary approaches: meta-learning and transfer learning. Meta-learning-based methods focus on acquiring generalizable features from a set of base classes, which can then be applied to identify novel classes. Transfer learning involves partially freezing network weights pretrained on a base dataset to improve a model's ability to generalize to novel classes with limited data. Transfer learning approaches often follow a two-stage fine-tuning strategy. In the first stage, training is performed on base classes, and in a second stage a fine-tune is performed of the box classifier and regressor with K-shots from novel classes.

### SUMMARY

In one or more illustrative examples, a method for outputting a fine-tuned model for few-shot object detection includes creating a dataset of K-shot classes for fine-tuning a pretrained vision language model (VLM); performing concept alignment between the dataset of K-shot classes and the VLM; fine-tuning the VLM using the dataset of K-shot classes with pseudo-negative federated loss to generate a few-shot object detection (FSOD) model; and outputting the FSOD model for use in object detection of the K-shot classes in image data received from one or more sensors.

In one or more illustrative examples, creating the dataset of K-shot classes includes selecting an image associated with one of a set of target classes; and adding the image to the dataset of K-shot classes if a total count of annotations for the target class in the image are less than or equal to K, until K annotations per target class of the set of target classes are added to the dataset of K-shot classes.

In one or more illustrative examples, performing the concept alignment includes compiling multimodal annotations for each target class, the multimodal annotations including textual descriptions and visual examples of the target class; and augmenting the textual descriptions with synonyms generated by querying a large language model (LLM) for descriptions of bounding box regions in the images of the target class.

In one or more illustrative examples, the multimodal annotations include materials used by human annotators for annotating images in the image set from which the K-shot classes are selected.

In one or more illustrative examples, the method further includes computing the pseudo-negative federated loss includes generating pseudo-positive predictions for each image in the dataset of K-shot classes; filtering the pseudo-positive predictions by confidence threshold to identify pseudo-positive classes; and identifying pseudo-negative classes by determining classes not included in the pseudo-positive predictions.

In one or more illustrative examples, the method further includes computing the pseudo-negative federated loss further includes combining the pseudo-negative classes with ground truth classes to form a set of selected classes; iterating over the selected classes to compute a binary cross-entropy (BCE) loss for each class by comparing FSOD model predictions with ground truth annotations; and summing the computed losses to obtain a total pseudo-negative federated loss.

In one or more illustrative examples, the method further includes determining the fine-tuning has converged based on stability of the total pseudo-negative federated loss and/or performance of the FSOD model on the object detection of the K-shot classes.

In one or more illustrative examples, the pretrained VLM comprises a Detic segmentation model or a Contrastive Language-Image Pretraining (CLIP) model trained on large-scale multi-modal data.

In one or more illustrative examples, the method further includes capturing pixel data using one or more sensors of a robot; applying the pixel data as input to the FSOD model to perform the object detection of the K-shot classes; and controlling one or more actuators of the robot based on a result of the object detection.

In one or more illustrative examples, a system for outputting a fine-tuned model for few-shot object detection includes one or more processors including instructions installed to one or more memories configured to create a dataset of K-shot classes for fine-tuning a pretrained vision language model (VLM); perform concept alignment between the dataset of K-shot classes and the VLM; fine-tune the VLM using the dataset of K-shot classes with pseudo-negative federated loss to generate a few-shot object detection (FSOD) model; and output the FSOD model for use in object detection of the K-shot classes in image data received from one or more sensors.

In one or more illustrative examples, the one or more processors are further configured to create the dataset of K-shot classes using operations including to select an image associated with one of a set of target classes; and add the image to the dataset of K-shot classes if a total count of annotations for the target class in the image are less than or equal to K, until K annotations per target class of the set of target classes are added to the dataset of K-shot classes.

In one or more illustrative examples, the one or more processors are further configured to perform the concept alignment using operations including to compile multimodal annotations for each target class, the multimodal annotations including textual descriptions and visual examples of the target class; and augment the textual descriptions with synonyms generated by querying a large language model (LLM) for descriptions of bounding box regions in the images of the target class.

In one or more illustrative examples, the multimodal annotations include materials used by human annotators for annotating images in the image set from which the K-shot classes are selected.

In one or more illustrative examples, the one or more processors are further configured to compute the pseudo-negative federated loss using operations including to generate pseudo-positive predictions for each image in the dataset of K-shot classes; filter the pseudo-positive predictions by confidence threshold to identify pseudo-positive classes; and identify pseudo-negative classes by determining classes not included in the pseudo-positive predictions.

In one or more illustrative examples, the one or more processors are further configured to compute the pseudo-negative federated loss using operations including to combine the pseudo-negative classes with ground truth classes to form a set of selected classes; iterate over the selected classes to compute a binary cross-entropy (BCE) loss for each class by comparing FSOD model predictions with ground truth annotations; and sum the computed losses to obtain a total pseudo-negative federated loss.

In one or more illustrative examples, the one or more processors are further configured to determine the fine-tuning has converged based on stability of the total pseudo-negative federated loss and/or performance of the FSOD model on the object detection of the K-shot classes.

In one or more illustrative examples, the pretrained VLM comprises a Detic segmentation model or a Contrastive Language-Image Pretraining (CLIP) model trained on large-scale multi-modal data.

In one or more illustrative examples, the system further includes a robot including the one or more sensors and one or more actuators, wherein the robot is configured to capture pixel data using the one or more sensors; apply the pixel data as input to the FSOD model to perform the object detection of the K-shot classes, and control the one or more actuators of the robot based on a result of the object detection.

In one or more illustrative examples, a non-transitory computer-readable medium includes instructions for outputting a fine-tuned model for few-shot object detection that, when executed by one or more processors, cause the one or more processors to perform operations including to create a dataset of K-shot classes for fine-tuning a pretrained vision language model (VLM); perform concept alignment between the dataset of K-shot classes and the VLM; fine-tune the VLM using the dataset of K-shot classes with pseudo-negative federated loss to generate a few-shot object detection (FSOD) model; and output the FSOD model for use in object detection of the K-shot classes in image data received from one or more sensors.

In one or more illustrative examples, the medium further includes instructions that, when executed by the one or more processors, cause the one or more processors to create the dataset of K-shot classes using operations including to select an image associated with one of a set of target classes; and add the image to the dataset of K-shot classes if a total count of annotations for the target class in the image are less than or equal to K, until K annotations per target class of the set of target classes are added to the dataset of K-shot classes.

In one or more illustrative examples, the medium further includes instructions that, when executed by the one or more processors, cause the one or more processors to perform the concept alignment using operations including to compile multimodal annotations for each target class, the multimodal annotations including textual descriptions and visual examples of the target class; and augment the textual descriptions with synonyms generated by querying a large language model (LLM) for descriptions of bounding box regions in the images of the target class.

In one or more illustrative examples, the multimodal annotations include materials used by human annotators for annotating images in the image set from which the K-shot classes are selected.

In one or more illustrative examples, the medium further includes instructions that, when executed by the one or more processors, cause the one or more processors to compute the pseudo-negative federated loss using operations including to generate pseudo-positive predictions for each image in the dataset of K-shot classes; filter the pseudo-positive predictions by confidence threshold to identify pseudo-positive classes; and identify pseudo-negative classes by determining classes not included in the pseudo-positive predictions.

In one or more illustrative examples, the medium further includes instructions that, when executed by the one or more processors, cause the one or more processors to compute the pseudo-negative federated loss using operations including to combine the pseudo-negative classes with ground truth classes to form a set of selected classes; iterate over the selected classes to compute a binary cross-entropy (BCE) loss for each class by comparing FSOD model predictions with ground truth annotations; and sum the computed losses to obtain a total pseudo-negative federated loss.

In one or more illustrative examples, the medium further includes instructions that, when executed by the one or more processors, cause the one or more processors to perform operations including to determine the fine-tuning has converged based on stability of the total pseudo-negative federated loss and/or performance of the FSOD model on the object detection of the K-shot classes.

In one or more illustrative examples, the pretrained VLM includes a Detic segmentation model or a Contrastive Language-Image Pretraining (CLIP) model trained on large-scale multi-modal data.

In one or more illustrative examples, the medium further includes instructions that, when executed by the one or more processors, cause the one or more processors to perform operations including to capture pixel data using one or more sensors of a robot; apply the pixel data as input to the FSOD model to perform object detection of the K-shot classes; and control one or more actuators of the robot based on a result of the object detection.

### BRIEF DESCRIPTION OF THE DRAWINGS

FIG. 1 illustrates an example system for fine-tuning to create a FSOD model;

FIG. 2A illustrates an example K-shot detection diagram using federated labels of object classes without information regarding other classes;

FIG. 2B illustrates an example K-shot detection diagram using federated labels of the object classes as well as pseudo labels of other classes;

FIG. 3 illustrates an example of misalignment between the vision language model (VLM) and the K-shot class annotations of the training dataset;

FIG. 4 illustrates an example of use of the VLM without and then with fine-tuning to perform concept alignment;

FIG. 5 illustrates an example process for performing the fine-tuning of the VLM using Pseudo-Negative Federated Loss to create the fine-tuned FSOD model;

FIG. 6 illustrates a schematic diagram of an interaction between a computer-controlled machine and a control system;

FIG. 7 illustrates a schematic diagram of the control system configured to control a robot using the fine-tuned FSOD model; and

FIG. 8 illustrates an example manufacturing system for anomaly detection using the fine-tuned FSOD model.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Object detection is a fundamental problem in computer vision that has matured in recent years. Given a large-scale annotated dataset, one can train a detector from scratch. However, training object detectors for domains with limited annotated data remains challenging, motivating the problem of few-shot object detection (FSOD).

Aspects of the disclosure relate to improving few shot object detection (FSOD) using pretrained foundational vision language models (VLMs) that are trained on large-scale collection of weakly-supervised image-text pairs, e.g., collected from the web.

Rather than explicitly filtering target classes from pre-training, VLMs pre-trained on (potentially private) web-scale data may be fine-tuned for the FSOD task. As VLMs pre-training datasets contain diverse concepts, it is challenging to prevent concept leakage. Since concept leakage is difficult to avoid, the disclosed approach instead embraces concept leakage. Pre-training on large-scale diverse base categories (which may overlap with novel concepts) may ultimately improve generalization to novel classes.

In another aspect, FSOD benchmarks may typically be constructed by partitioning popular object detection datasets, such as PASCAL VOC and COCO, into base categories (with many examples per class) and target novel categories (with few examples per class). Detectors may be first pre-trained on base classes and finetuned on K examples (or K-shots) from novel classes. These FSOD benchmarks enforce base and novel classes to be disjoint to prevent concept leakage and measure generalization to unseen categories. However, as most detectors are pre-trained on ImageNet, concept leakage already occurs in contemporary benchmarks. For example, cat and person are considered novel in the COCO FSOD benchmark but are already present in ImageNet. Similarly, car is considered novel even though similar concepts like sports car and race car are present in ImageNet.

Aspects of the disclosure thus provide two enhancements in view of benchmarks. First, the approach modernizes FSOD benchmarks by embracing vision-language foundation models that are pretrained on Internet-scale data. This highlights a practical challenge of using multi-modal few-shot examples to define the target semantic concept. Second, the approach identifies that existing FSOD benchmarks are actually federated datasets, and presents simple strategies for fine-tuning VLMs. Further aspects of the disclosure are discussed in detail herein.

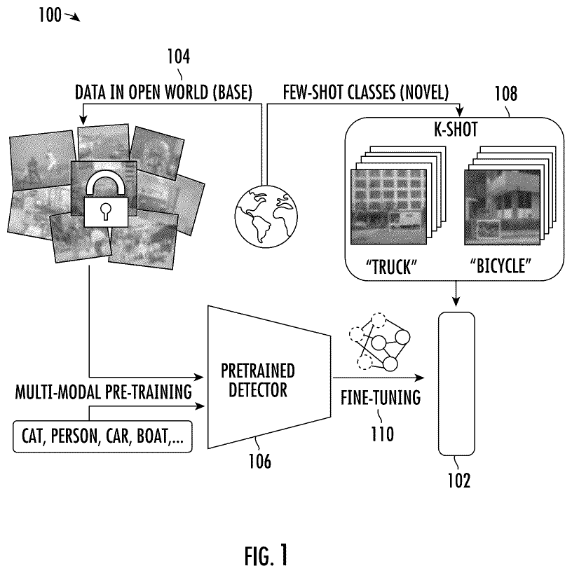

FIG. 1 illustrates an example system 100 for performing fine-tuning 110 to create a fine-tuned few-shot object detection (FSOD) model 102 using a VLM 106. The system includes collection of base multi-modal data 104 which is used for pretraining of a VLM 106. Using K-shot classes 108, the VLM 106 undergoes fine-tuning 110 to create a fine-tuned FSOD model 102.

The base multi-modal data 104 may be a large, varied dataset of open world data, such as web data. Purely for sake of example, the base multi-modal data 104 may include image data of various base or common classes, such as cats, persons, cars, and boats. The base multi-modal data 104 may also include data of other types, here shown as textual data descriptive of the image data, but other modalities of data such as audio labels may additionally or alternative be used. As discussed herein, image data may include an array of pixel data, where each pixel represents aspects of an image captured, acquired, or otherwise determined. The image data may be captured at various resolutions, dynamic range, fields of view, frequencies, and color channels.

The VLM 106 may be a multi-modal foundation model that is trained using the base multi-modal data 104, enabling the VLM 106 to recognize common objects classes effectively. The multi-modal nature of the VLM 106 indicates that the model integrates various types of base multi-modal data 104, including images and other modalities such as text as noted above, to enhance its generalization capabilities. Example VLMs 106 may include the Detic segmentation model specifically designed for object detection developed by Meta, the Contrastive Language-Image Pretraining (CLIP) models developed by OpenAI, the Multitask Unified Model (MUM) trained by Alphabet, the Florence model developed by Microsoft, etc. Regardless of which model is used, the VLM 106 may operate as a pre-trained detector that is capable of detecting a wide range of objects.

The K-shot classes 108 refers to a small number of images (K-shots) of various novel categories. Few-shot classes such as Truck and Bicycle are shown, indicating that the system 100 may fine-tune the parameters of the VLM 106 using only a small number of images (K-shots) of these new categories. This fine-tuning process is useful for adapting the VLM 106 to detect classes of objects that were not included in the original base multi-modal data 104 training dataset.

The fine-tuning 110 refers to a process whereby the VLM 106 is adjusted based on the K-shot classes 108 to create the fine-tuned FSOD model 102. The fine-tuning 110 involves updating the weights of the VLM 106 to improve its accuracy on these new classes while retaining its ability to recognize the base classes from the initial training phase with the base multi-modal data 104. By combining multi-modal pre-training with the fine-tuning 110 on few-shot classes, the system 100 provides a flexible and efficient object detection system capable of adapting to new and unseen objects with minimal additional data.

Given the scale and often private nature of the base multi-modal data 104 used to train the VLM 106, it may be impractical to maintain a split of base and novel classes as might traditionally be done for the fine-tuning 110 on K-shots of novel classes. Instead, the disclosed approach directly fine-tunes the VLM 106 on K-shots of the target classes, e.g., the K-shot classes 108. The fine-tuned FSOD model 102 is also evaluated on those target classes. Importantly, VLMs 106 allow the exploitation of additional language cues such as class names and descriptions for the fine-tuning 110.

One use case for the fine-tuning 110 to generate the fine-tuned FSOD model 102 is multi-modal concept alignment. The strong zero-shot performance of VLMs 106 implies that few-shot detection is no longer an interesting problem. Yet, it may be found that a target class name is often an insufficient description of the target concept. For example, a trailer in the nuImages dataset may be defined differently than a trailer in the base multi-modal data 104.

Human annotators may require few-shot instructions to identify subtle aspects of the target concept. Such annotator instructions are naturally multimodal, often including visual examples and textual descriptions. A FSOD setup that uses similar visual and language cues may be used for concept alignment of a VLM 106.

To effectively align VLM 106 concepts with K-shot multi-modal instructions, the observation is made that FSOD datasets are actually federated datasets. A federated dataset is a dataset comprised of smaller subsets, where each subset is exhaustively annotated for only a single category. For example, cars may or may not appear in the background of the K images annotated with motorcycles. Importantly, existing FSOD methods incorrectly assume that no cars (or other classes) are present in the background of non-car images.

As discussed in detail herein, fine-tuning VLMs 106 with federated losses consistently improves over zero-shot inference. To do so, the VLM 106 is fine-tuned with Federated Loss (FedLoss) using a subset S of classes C for each training image. Specifically, a binary crossentropy loss on all classes in S is used, where classes outside of S are ignored during training. S is comprised of the ground-truth annotation class along with randomly sampled negative classes for each image. These negative classes as sampled in proportion to their square-root frequency in the training set. It may be seen that probabilistically sampling negatives rather than labeling all unannotated classes as negatives improves finetuning results, reliably beating zero-shot performance. Importantly, although FedLoss has been explored in the context of long-tailed detection, applying it to FSOD provides considerable performance improvements, reaffirming that FSOD benchmarks are actually federated datasets.

FedLoss samples common classes (such as car) more frequently as negatives, hurting detection accuracy for long-tailed datasets like LVIS and nuImages. Instead, an Inverse FedLoss (InvFedLoss) may be used, which is a minor modification of FedLoss that samples negative categories in proportion to the inverse of their square-root frequency. This ensures that rare categories are sampled as negatives more frequently to better match the true data distribution. Leveraging this insight improves over FedLoss and naive fine-tuning 110.

Despite the effectiveness of InvFedLoss, probabilistically sampling negatives using dataset-wide statistics is sub-optimal because it does not consider the content of each image. The accuracy of sampled negatives can also be improved with pseudo-labels to determine which classes are likely not in a particular image. If the maximal score for any class prediction is less than a threshold, this class is considered to be a negative. Using image predictions to identify pseudo-negatives yields better results than simply using dataset-wide statistics.

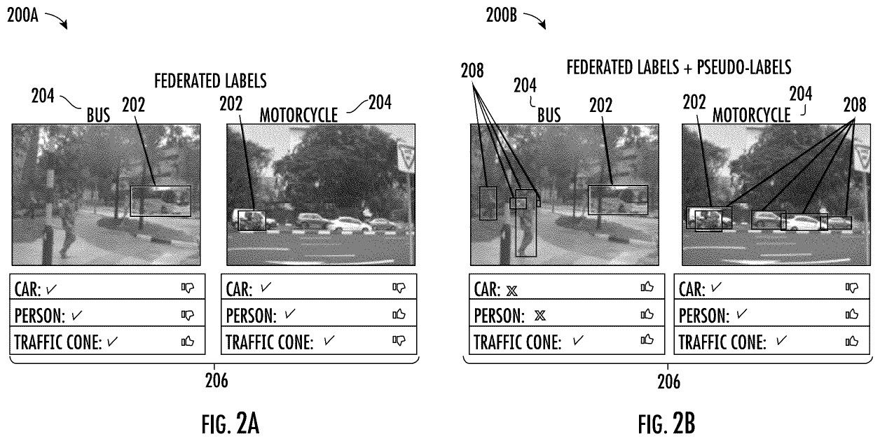

FIG. 2A illustrates an example K-shot detection diagram 200A using federated labels 202 of object classes 204 without information regarding other classes 206. FIG. 2B illustrates an example K-shot detection diagram 200B using federated labels 202 of the object classes 204 as well as pseudo labels 208 of other classes 206. The other classes 206 are illustrated with a ✓ to denote that a given image will be treated as a negative example of a given other class 206 by the learner and an χ to denote that a given image will be ignored when learning a given other class 206. The other classes 206 also utilize a thumbs-up icon to indicate that the label is correctly a negative example, and a thumbs-down icon to indicate that the label is incorrectly a negative example.

Each of the diagrams 200A, 200B illustrates a labeling of a bus object class 204 and a labeling of a motorcycle object class 204. This may be considered a federated dataset, where one is given multiple mini-datasets of K images of a given class. In this case, each of the diagrams 200A, 200B may be visualized as two K=1 datasets of bus and motorcycle.

Yet, each dataset does not provide information about the presence of other objects outside of the dataset. Existing FSOD approaches may ignore this fact, and instead assume the collective set of few-shot images are fully annotated across all object classes 204 (meaning that it is assumed that the dataset for one class does not include any instances of other classes also being trained on). This will likely produce many incorrect negative labels as shown in the diagram 200A. As an example of incorrect negative labeling, all unlabeled cars in the background of the motorcycle mini-dataset may be incorrectly treated as negative cars. Naive FSOD approaches learn about all classes from all images, which results in many incorrect negative labels, as shown by the many thumbs-down icons in the diagram 200A.

To address this, the partially labeled nature of the datasets may be used along with tools from weakly-supervised learning, such as the use of pseudo labels 208 predicted by a teacher. For example, image recognition may be performed on each of the images of each of the datasets to determine whether any of the other classes also being trained on are present in the images with at least a predefined threshold confidence. If so, then these detections may be applied to the images as pseudo labels 208. In an example, these predictions are performing using the VLM 106 before the fine-tuning 110. In another example, these predictions are performed using another VLM 106.

The fine-tuning 110 of the VLM 106 on the mini-dataset in combination with thresholded pseudo-detections (shown as the additional detection boxes in the diagram 200B) may be performed to find images that can be confidently treated as (pseudo) negatives, which results in much fewer mistakes as shown in the diagram 200B. This in turns produces improved performance. (It may also be possible in other examples to apply pseudo positive labels, but these may be found to be less reliable.)

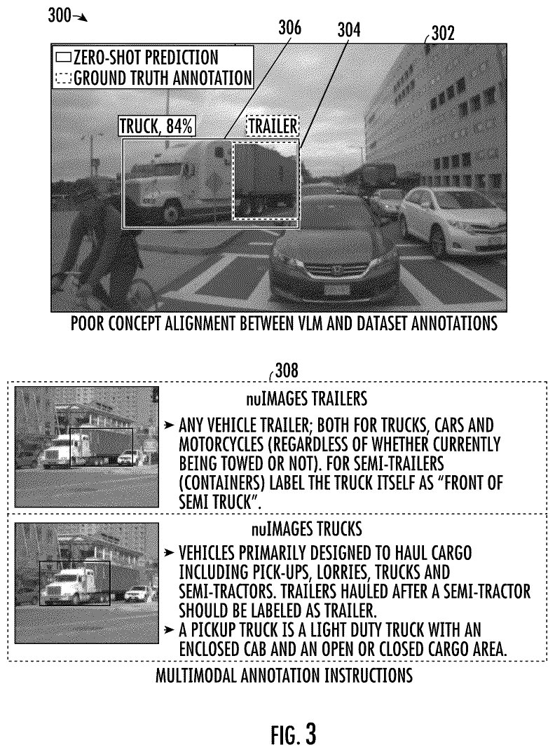

FIG. 3 illustrates an example 300 of misalignment between the VLM 106 and the K-shot class 108 annotations of the training dataset. Although VLMs 106 may show impressive zero-shot performance, they struggle when the target class is different from concepts encountered in web-scale training. On the top, an image 302 is shown with a ground truth annotation 304 from the image dataset and also a zero-shot prediction 306 made by the VLM 106. Here, it can be seen that the nuImages dataset defines the cab of the truck as a separate concept from its trailer. In contrast, the VLM 106 predicts the entire vehicle as a truck.

On the bottom, the actual class definitions given to the nuImages annotators are shown, provided as both textual descriptions and visual examples of the classes to be identified. These annotations may be referred to herein as multimodal annotations 308. As human annotators learn concepts from few-shot multi-modal examples, the VLMs 106 should be similarly fine-tuned with K vision-language examples.

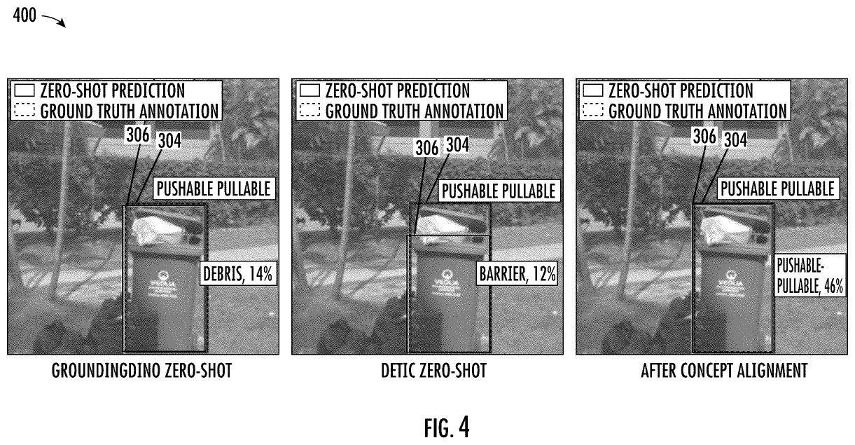

FIG. 4 illustrates an example 400 of use of the VLM 106 without and then with the fine-tuning 110 to perform concept alignment. Each VLM 106 is shown with ground truth annotation 304 from the image dataset and also a zero-shot prediction 306 made by the VLM 106. Here, the left (GroundingDino) and center (Detric) show that different VLMs 106 struggle to detect open-world categories like pushable-pullable. Yet, the fine-tuning 110 of the VLM 106 (right) with federated losses using the multimodal annotations 308 improves the concept alignment of the VLM 106 to be more consistent with the annotations to the image dataset. The results for each of various VLMs 106 is shown with both the ground-truth annotations and the predictions by the respective VLM 106.

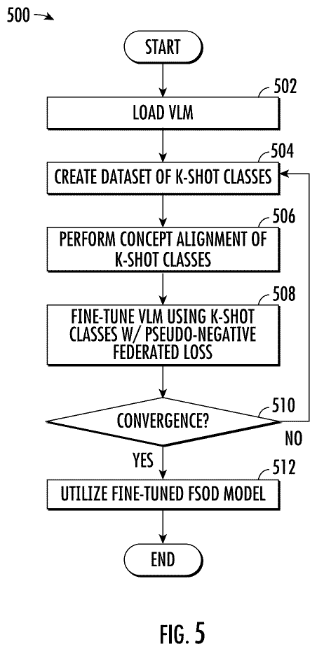

FIG. 5 illustrates an example process 500 for performing the fine-tuning 110 of the VLM 106 using Pseudo-Negative Federated Loss to create the fine-tuned FSOD model 102. In an example the process 500 may be performed as discussed in detail throughout this disclosure.

At operation 502, the VLM 106 to be fine-tuned is loaded. This VLM 106 may be the Detic segmentation model, the CLIP model, or any other multi-modal foundation model that is trained using large-scale base multi-modal data 104.

At operation 504, a dataset of K-shot classes 108 is created. This dataset may include, for example, K images of each novel class to be recognized by the fine-tuned FSOD model 102. To construct the dataset of K-shot classes 108, a set of classes C relevant to the specific application being performed may be defined as the target classes. Then, a target class C is selected and an image is selected at random. In many examples herein, the images are selected from image sets such as ImageNet or nuImages, but these are only examples. If the total annotations for class C in the image are less than or equal to K, the image is added to the dataset. This process is repeated for all classes C until there are K annotations per class. Each example in the K-shot classes 108 may accordingly include an image and also a textual description of the class C.

At operation 506, concept alignment is performed of the dataset of K-shot classes 108 and the VLM 106. In many examples, the concept alignment may be performed on the set of classes C that are relevant to the specific application, because these are the classes that it is desired to be accurately detected. These target classes may be reviewed between the image set from which the K-shot classes 108 are selected and the alignment of the VLM 106 in its detection of the target classes C and/or of similar classes.

In an example, multimodal annotations 308 including textual descriptions for each target class C and also visual examples that accurately depict the target concepts may be compiled. In some examples, these multimodal annotations 308 may include materials used by human annotators in annotating the images of the image set. In another example, the multimodal annotations 308 may include data from a multimedia dataset such as MQ-Det, which uses both textual descriptions and open-set generalizations and visual exemplars with rich description granularity as category queries.

In some examples, the textual portion of the annotations may be augmented with synonyms to improve classification accuracy. These symptoms may be generated, in some examples, by querying a large language model for a description of a bounding box region in the image of an example of the target class, and then adding the resultant descriptions to the textual portion of the multimodal annotations 308 as additional synonyms.

At operation 508, the VLM 106 is fine-tuned using the K-shot classes 108 with pseudo-negative federated loss. In particular, the loss for the fine-tuning 110 may be performed using the following algorithm designed to compute a loss value for using pseudo-negatives.

```
# Step 1: Compute Predictions and Filter by Confidence
pred = Detector(img) #predictions
pseudo_pos = filter(pred, thresh = 0.2)
# Step 2: Get Pseudo-Negatives for Image
neg_classes = get_neg(pseudo_pos, all_classes)
select_classes = or(neg_classes, gt_classes)
#Step 3: Compute Deterministic Federated Loss w/Pseudo-
Negatives
loss = 0
for cls in select_classes:
  pred_cls = pred[cls] #predictions for cls
  gt_cls = gt[cls] #ground-truth for cls
  loss += BCE(pred_cls, gt_cls)
return loss
```

As shown, the inputs and outputs are as follows:
img: A randomly sampled image.
all_classes: A list of all classes in the dataset.
gt: Ground truth annotations for the image img.
gt_classes: A list of classes present in the ground truth annotations gt.
loss: The output of the function, representing the Pseudo-Negative Federated Loss.

The filter function returns all predictions with a confidence score above a certain threshold. The get_neg function returns a list of classes that are not in the pseudo-positive predictions. The or function is a set union operation, combining two sets of classes. The BCE function refers to Binary Cross Entropy Loss, which is a common loss function used for binary classification tasks. The loss function operates as follows:

First, at Step 1, the function computes predictions and filters by confidence. A detector model is used to compute predictions for the image img. The predictions include confidence scores for each class. Then, the predictions are filtered to retain only those with a confidence score greater than a predefined confidence threshold (in the example code the threshold is 0.2), creating a list of pseudo-positive classes, pseudo_pos.

Next, at Step 2, the pseudo-negative classes, neg_classes, are determined by identifying the classes in all_classes that are not in pseudo_pos. Then, the pseudo-negative classes neg_classes are combined with the ground truth classes gt_classes using the union operation. This gives a list of classes, here select_classes, to consider for loss computation.

Then, at Step 3, deterministic federated loss with the pseudo-negatives is computed. To do so, loss is initialized to zero. Next, the function iterates over the classes in the select_classes set. For each class cls of select_classes, the predictions made for the class cls by the detector at Step 1 are retrieved. Additionally, the ground truth for the class cls is retrieved from ground truth annotations for the image being processed. Then, the BCE loss between the predicted values and the ground truth for the current class cls is computed and added to the total loss. Once the iteration is complete, the loss is returned.

Overall, the pseudo-negative federated loss function calculates the federated loss by considering both pseudo-negatives (classes not predicted with high confidence) and ground truth classes, ensuring that fine tuning of the VLM 106 is learned from a broader set of classes for improving its generalization capability.

At operation 510, it is determined whether there is convergence of the fine-tuned FSOD model 102. For example, the process 500 is repeated until the loss stabilizes, and the fine-tuned FSOD model 102 performance meets desired criteria. If there is convergence, control proceeds to operation 510. If not, control returns to operation 504.

At operation 512, the fine-tuned FSOD model 102 is utilized for recognition of the novel classes in new images. For example, the fine-tuned FSOD model 102 may be used to classify objects detected by sensors of a robot to aid in control of the robot. After operation 512, the process 500 ends.

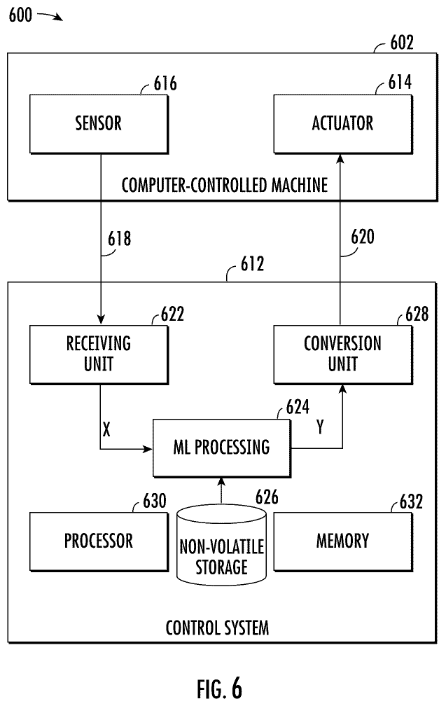

FIG. 6 illustrates a schematic diagram 600 of an interaction between a computer-controlled machine 602 and a control system 612. The computer-controlled machine 602 may implement aspects of the fine-tuning 110 of the VLM 106 and/or use of the fine-tuned FSOD model 102. Referring to FIG. 6, and with reference to FIGS. 1-5, the approaches discussed herein may be performed in the context of such a computer-controlled machine 602 and control system 612. The computer-controlled machine 602 includes actuator 614 and sensor 616. Actuator 614 may include one or more actuators and sensor 616 may include one or more sensors. Sensor 616 is configured to sense a condition of computer-controlled machine 602. Sensor 616 may be configured to encode the sensed condition into sensor signals 618 and to transmit sensor signals 618 to control system 612. Non-limiting examples of sensor 616 include video, radar, LiDAR, ultrasonic and motion sensors. In one embodiment, sensor 616 is an optical sensor configured to sense optical images of an environment proximate to computer-controlled machine 602.

The control system 612 is configured to receive the sensor signals 618 from the computer-controlled machine 602. The control system 612 may be further configured to compute actuator control commands 620 depending on the sensor signals and to transmit actuator control commands 620 to the actuator 614 of computer-controlled machine 602.

As shown in FIG. 6, control system 612 includes receiving unit 622. Receiving unit 622 may be configured to receive sensor signals 618 from sensor 616 and to transform sensor signals 618 into input signals X. In an alternative embodiment, sensor signals 618 are received directly as input signals X without receiving unit 622. Each input signal x may be a portion of each sensor signal 618. Receiving unit 622 may be configured to process each sensor signal 618 to product each input signal x. Input signal x may include data corresponding to an image recorded by sensor 616.

Control system 612 includes machine learning (ML) processing 624. ML processing 624 may be configured to learn, classify, infer, generate, etc. using one or more models such as those described in detail above. In an example, ML processing 624 is configured to determine output signals Y from input signals X. Each output signal y includes information that assigns one or more labels to each input signal X. ML processing 624 may transmit output signals Y to conversion unit 628. Conversion unit 628 is configured to convert output signals Y into actuator control commands 620. Control system 612 is configured to transmit actuator control commands 620 to actuator 614, which is configured to actuate computer-controlled machine 602 in response to actuator control commands 620. In another embodiment, actuator 614 is configured to actuate computer-controlled machine 602 based directly on output signals Y.

Upon receipt of actuator control commands 620 by actuator 614, actuator 614 is configured to execute an action corresponding to the related actuator control command 620. Actuator 614 may include a control logic configured to transform actuator control commands 620 into a second actuator control command 620, which is utilized to control actuator 614. In one or more embodiments, actuator control commands 620 may be utilized to control a display instead of or in addition to an actuator 614.

In another embodiment, control system 612 includes sensor 616 instead of or in addition to computer-controlled machine 602 including sensor 616. Control system 612 may also include actuator 614 instead of or in addition to computer-controlled machine 602 including actuator 614.

As shown in FIG. 6, control system 612 also includes processor 630 and memory 632. Processor 630 may include one or more processors. Memory 632 may include one or more memory devices. The fine-tuned FSOD model 102 (e.g., ML algorithms) of one or more embodiments may be implemented by control system 612, which includes non-volatile storage 626, processor 630 and memory 632.

Non-volatile storage 626 may include one or more persistent data storage devices such as a hard drive, optical drive, tape drive, non-volatile solid-state device, cloud storage or any other device capable of persistently storing information. Processor 630 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 632. Memory 632 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 630 may be configured to read into memory 632 and execute computer-executable instructions residing in non-volatile storage 626 and embodying one or more ML algorithms and/or methodologies of one or more embodiments. Non-volatile storage 626 may include one or more operating systems and applications. Non-volatile storage 626 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

Upon execution by processor 630, the computer-executable instructions of non-volatile storage 626 may cause control system 612 to implement one or more of the ML algorithms and/or methodologies as disclosed herein. Non-volatile storage 626 may also include ML data (including data parameters) supporting the functions, features, and processes of the one or more embodiments described herein.

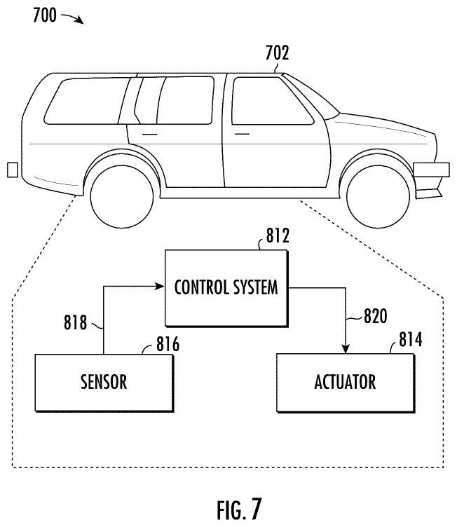

FIG. 7 illustrates a schematic diagram 700 of the control system 612 configured to control a robot using the fine-tuned FSOD model. The robot may be an at least partially autonomous vehicle 702 or an at least partially autonomous robot. As shown in FIG. 7, the vehicle 702 includes an actuator 614 and a sensor 616. The sensor 616 may include one or more video sensors, radar sensors, ultrasonic sensors, LiDAR sensors, and/or position sensors (e.g., global navigation satellite system (GNSS)). One or more of the one or more specific sensors may be integrated into the vehicle 702. Alternatively, or in addition to one or more specific sensors identified above, the sensors 616 may include a software module configured to, upon execution, determine a state of the actuator 614. One non-limiting example of a software module includes a weather information software module configured to determine a present or future state of the weather proximate vehicle 702 or other location.

The ML processing 624 of the control system 612 of the vehicle 702 may be configured to detect objects in the vicinity of the vehicle 702 dependent on input signals X. In such an embodiment, output signal Y may include information characterizing the vicinity of objects to the vehicle 702. An actuator control command 620 may be determined in accordance with this information. The actuator control command 620 may be used to avoid collisions with the detected objects.

In embodiments where the vehicle 702 is an at least partially autonomous vehicle, the actuator 614 may be embodied in a brake, a propulsion system, an engine, a drivetrain, or a steering of the vehicle 702. The actuator control commands 620 may be determined such that the actuator 614 is controlled such that the vehicle 702 avoids collisions with detected objects. The objects may be detected and or classified according to the fine-tuned FSOD model 102, For example, the categorization may include what the fine-tuned FSOD model 102 deems them most likely to be, such as pedestrians or trees. The actuator control commands 620 may be determined depending on the classification.

In other embodiments where the vehicle 702 is an at least partially autonomous robot, the vehicle 702 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 620 may be determined such that a propulsion unit, steering unit and/or brake unit of the mobile robot may be controlled such that the mobile robot may avoid collisions with identified objects as detected using the fine-tuned FSOD model 102.

In another embodiment, the vehicle 702 is an at least partially autonomous robot in the form of a gardening robot. In such embodiment, the vehicle 702 may use an optical sensor as sensor 616 to determine a state of plants in an environment proximate the vehicle 702. The actuator 614 may be a nozzle configured to spray chemicals. Depending on an identified species and/or an identified state of the plants determined using the fine-tuned FSOD model 102, the actuator control command 620 may be determined to cause the actuator 614 to spray the plants with a suitable quantity of suitable chemicals.

The vehicle 702 may be an at least partially autonomous robot in the form of a domestic appliance. Non-limiting examples of domestic appliances include a washing machine, a stove, an oven, a microwave, or a dishwasher. In such a vehicle 02, the sensor 916 may be an optical sensor configured to detect a state of an object which is to undergo processing by the household appliance, where pixel data from the sensor may be applied to the fine-tuned FSOD model 102 for detection.

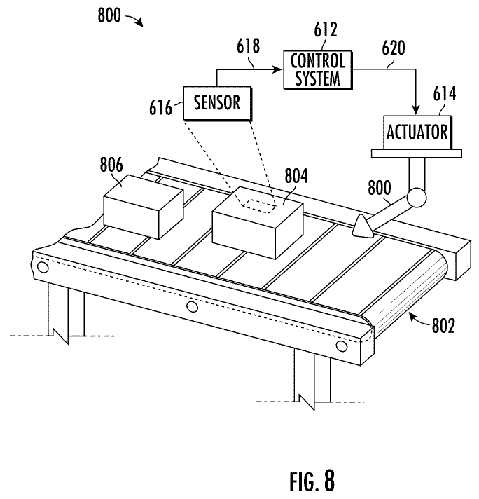

FIG. 8 illustrates an example manufacturing system 800 for use in anomaly detection. The system 800 may be configured to control a manufacturing machine 802, such as a punch cutter, a cutter or a gun drill, etc., such as part of a production line.

The system 800 may be configured to control an actuator 614, which is configured to control the manufacturing machine 802. A sensor 616 of the system 800 may be configured to capture one or more properties of a manufactured product 804. ML processing 624 may be configured to determine a state of the manufactured product 804 from one or more of the captured properties. An actuator 614 may be configured to control the system 800 (e.g., a manufacturing machine) depending on the determined state of the manufactured product 804 for a subsequent manufacturing step of the manufactured product 804. In particular, the actuator 614 may be configured to control functions of system 800 (e.g., the manufacturing machine) on subsequent manufactured product 806 of the system 800 (e.g., the manufacturing machine) depending on the determined state of the manufactured product 804. Here again, a sensor may capture pixel data which may be applied to the fine-tuned FSOD model 102 for object detection, which in turn may be used to determine the state information.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for outputting a fine-tuned model for few-shot object detection, the method comprising:
creating a dataset of K-shot classes for fine-tuning a pretrained vision language model (VLM);
performing concept alignment between the dataset of K-shot classes and the VLM;
fine-tuning the VLM using the dataset of K-shot classes with a pseudo-negative federated loss to generate a few-shot object detection (FSOD) model; and
outputting the FSOD model for use in object detection of the K-shot classes in image data received from one or more sensors.

2. The method of claim 1, wherein creating the dataset of K-shot classes includes:
selecting an image associated with one of a set of target classes; and
adding the image to the dataset of K-shot classes if a total count of annotations for the target class in the image are less than or equal to K, until K annotations per target class of the set of target classes are added to the dataset of K-shot classes.

3. The method of claim 2, wherein performing the concept alignment includes:
compiling multimodal annotations for each target class, the multimodal annotations including textual descriptions and visual examples of the target class; and
augmenting the textual descriptions with synonyms generated by querying a large language model (LLM) for descriptions of bounding box regions in the images of the target class.

4. The method of claim 3, wherein the multimodal annotations include materials used by human annotators for annotating images in the image set from which the K-shot classes are selected.

5. The method of claim 1, wherein computing the pseudo-negative federated loss includes:
generating pseudo-positive predictions for each image in the dataset of K-shot classes;
filtering the pseudo-positive predictions by confidence threshold to identify pseudo-positive classes; and
identifying pseudo-negative classes by determining classes not included in the pseudo-positive predictions.

6. The method of claim 5, wherein computing the pseudo-negative federated loss further includes:
combining the pseudo-negative classes with ground truth classes to form a set of selected classes;
iterating over the selected classes to compute a binary cross-entropy (BCE) loss for each class by comparing FSOD model predictions with ground truth annotations; and
summing the computed losses to obtain a total pseudo-negative federated loss.

7. The method of claim 6, further comprising determining the fine-tuning has converged based on stability of the total pseudo-negative federated loss and/or performance of the FSOD model on the object detection of the K-shot classes.

8. The method of claim 1, wherein the pretrained VLM comprises a Detic segmentation model or a Contrastive Language-Image Pretraining (CLIP) model trained on large-scale multi-modal data.

9. The method of claim 1, further comprising:
capturing pixel data using one or more sensors of a robot;
applying the pixel data as input to the FSOD model to perform the object detection of the K-shot classes; and
controlling one or more actuators of the robot based on a result of the object detection.

10. A system for outputting a fine-tuned model for few-shot object detection, the system comprising:
one or more processors including instructions installed to one or more memories configured to:
create a dataset of K-shot classes for fine-tuning a pretrained vision language model (VLM);
perform concept alignment between the dataset of K-shot classes and the VLM;
fine-tune the VLM using the dataset of K-shot classes with pseudo-negative federated loss to generate a few-shot object detection (FSOD) model; and
output the FSOD model for use in object detection of the K-shot classes in image data received from one or more sensors.

11. The system of claim 10, wherein the one or more processors are further configured to create the dataset of K-shot classes using operations including to:
select an image associated with one of a set of target classes; and
add the image to the dataset of K-shot classes if a total count of annotations for the target class in the image are less than or equal to K, until K annotations per target class of the set of target classes are added to the dataset of K-shot classes.

12. The system of claim 11, wherein the one or more processors are further configured to perform the concept alignment using operations including to:
compile multimodal annotations for each target class, the multimodal annotations including textual descriptions and visual examples of the target class; and
augment the textual descriptions with synonyms generated by querying a large language model (LLM) for descriptions of bounding box regions in the images of the target class.

13. The system of claim 12, wherein the multimodal annotations include materials used by human annotators for annotating images in the image set from which the K-shot classes are selected.

14. The system of claim 10, wherein the one or more processors are further configured to compute the pseudo-negative federated loss using operations including to:
generate pseudo-positive predictions for each image in the dataset of K-shot classes;
filter the pseudo-positive predictions by confidence threshold to identify pseudo-positive classes; and
identify pseudo-negative classes by determining classes not included in the pseudo-positive predictions.

15. The system of claim 14, wherein the one or more processors are further configured to compute the pseudo-negative federated loss using operations including to:
combine the pseudo-negative classes with ground truth classes to form a set of selected classes;
iterate over the selected classes to compute a binary cross-entropy (BCE) loss for each class by comparing FSOD model predictions with ground truth annotations; and
sum the computed losses to obtain a total pseudo-negative federated loss.

16. The system of claim 15, wherein the one or more processors are further configured to determine the fine-tuning has converged based on stability of the total pseudo-negative federated loss and/or performance of the FSOD model on the object detection of the K-shot classes.

17. The system of claim 10, wherein the pretrained VLM comprises a Detic segmentation model or a Contrastive Language-Image Pretraining (CLIP) model trained on large-scale multi-modal data.

18. The system of claim 10, further comprising a robot including the one or more sensors and one or more actuators, the robot configured to:
capture pixel data using the one or more sensors;
apply the pixel data as input to the model to perform the object detection of the K-shot classes, and
control the one or more actuators of the robot based on a result of the object detection.

19. A non-transitory computer-readable medium comprising instructions for providing a fine-tuned model for few-shot object detection that, when executed by one or more processors, cause the one or more processors to perform operations including to:
create a dataset of K-shot classes for fine-tuning a pretrained vision language model (VLM);
perform concept alignment between the dataset of K-shot classes and the VLM;
fine-tune the VLM using the dataset of K-shot classes with pseudo-negative federated loss to generate a few-shot object detection (FSOD) model; and
output the FSOD model for use in object detection of the K-shot classes in image data received from one or more sensors.

20. The non-transitory computer-readable medium of claim 19, further comprising instructions that, when executed by the one or more processors, cause the one or more processors to create the dataset of K-shot classes using operations including to:
select an image associated with one of a set of target classes; and
add the image to the dataset of K-shot classes if a total count of annotations for the target class in the image are less than or equal to K, until K annotations per target class of the set of target classes are added to the dataset of K-shot classes.

21. The non-transitory computer-readable medium of claim 20, further comprising instructions that, when executed by the one or more processors, cause the one or more processors to perform the concept alignment using operations including to:
compile multimodal annotations for each target class, the multimodal annotations including textual descriptions and visual examples of the target class; and
augment the textual descriptions with synonyms generated by querying a large language model (LLM) for descriptions of bounding box regions in the images of the target class.

22. The non-transitory computer-readable medium of claim 21, wherein the multimodal annotations include materials used by human annotators for annotating images in the image set from which the K-shot classes are selected.

23. The non-transitory computer-readable medium of claim 19, further comprising instructions that, when executed by the one or more processors, cause the one or more processors to compute the pseudo-negative federated loss using operations including to:
generate pseudo-positive predictions for each image in the dataset of K-shot classes;
filter the pseudo-positive predictions by confidence threshold to identify pseudo-positive classes; and
identify pseudo-negative classes by determining classes not included in the pseudo-positive predictions.

24. The non-transitory computer-readable medium of claim 23, further comprising instructions that, when executed by the one or more processors, cause the one or more processors to compute the pseudo-negative federated loss using operations including to:
combine the pseudo-negative classes with ground truth classes to form a set of selected classes;
iterate over the selected classes to compute a binary cross-entropy (BCE) loss for each class by comparing FSOD model predictions with ground truth annotations; and
sum the computed losses to obtain a total pseudo-negative federated loss.

25. The non-transitory computer-readable medium of claim 24, further comprising instructions that, when executed by the one or more processors, cause the one or more processors to perform operations including to determine the fine-tuning has converged based on stability of the total pseudo-negative federated loss and/or performance of the FSOD model on the object detection of the K-shot classes.

26. The non-transitory computer-readable medium of claim 19, wherein the pretrained VLM comprises a Detic segmentation model or a Contrastive Language-Image Pretraining (CLIP) model trained on large-scale multi-modal data.

27. The non-transitory computer-readable medium of claim 19, further comprising instructions that, when executed by the one or more processors, cause the one or more processors to perform operations including to:
capture pixel data using one or more sensors of a robot;
apply the pixel data as input to the FSOD model to perform the object detection of the one or more K-shot classes; and
control one or more actuators of the robot based on a result of the object detection.
